(19) United States
(12) Patent Application Publication
(10) Pub. No.: US 2016/0353484 A1
(43) Pub. Date: Dec. 1, 2016

(54) EFFICIENT RANDOM SCHEDULED CHANNEL ACCESS

(71) Applicant: QUALCOMM Incorporated, San Diego, CA (US)

(72) Inventor: Maarten Menzo Wentink, Naarden (NL)

(21) Appl. No.: 15/163,521

(22) Filed: May 24, 2016

Related U.S. Application Data
(60) Provisional application No. 62/167,602, filed on May 28, 2015.

(51) Int. Cl. H04W 74/08

(52) U.S. Cl. CPC H04W 74/0833; H04W 74/0816

(57) ABSTRACT

Systems and methods are disclosed that may allow a wireless device to arrange a scheduled access interval (SAI). For example, a method for arranging an SAI may include reserving a wireless medium for scheduled access during a first interval, determining a guard time, within the first interval, wherein no scheduled transmissions are to occur, and performing one or more unscheduled transmissions via the wireless medium during the guard time.

### RELATED APPLICATION

This application claims priority to U.S. Provisional Patent Application No. 62/167,602, titled “Efficient Random Scheduled Channel Access,” filed May 28, 2015, which is hereby incorporated by reference in its entirety.

### TECHNICAL FIELD

The example embodiments relate generally to wireless networks, and specifically to the coexistence of classes of wireless devices having differing channel access protocols.

### BACKGROUND OF RELATED ART

A wireless local area network (WLAN) may be formed by one or more access points (APs) that provide a shared wireless communication medium for use by a number of client devices or stations (STAs). Each AP, which may correspond to a Basic Service Set (BSS), periodically broadcasts beacon frames to enable any STAs within wireless range of the AP to establish and/or maintain a communication link with the WLAN. In a typical WLAN, only one STA may use the wireless medium at any given time, and each STA may be associated with only one AP at a time.

Wireless devices in a WLAN may support different channel access protocols. For example, legacy wireless devices may not support newer channel access protocols. Thus, wireless communications by legacy devices may interrupt and/or interfere with wireless communications by newer devices (e.g., using newer channel access protocols). Accordingly, it would be desirable to allow newer channel access protocols to be used without interruption from legacy wireless devices.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

Apparatus and methods are disclosed that may allow a wireless device to arrange a scheduled access interval (SAI). In one example, a method of arranging an SAI is disclosed. The method may include: reserving a wireless medium for scheduled access during a first interval; determining a guard time within the first interval, wherein no scheduled transmissions are to occur; and performing one or more unscheduled transmissions via the wireless medium during the guard time.

In another example, a wireless device for arranging a scheduled access interval (SAI) is disclosed. The wireless device may include one or more processors, and a memory storing one or more programs including instructions that, when executed by the one or more processors, cause the wireless device to: reserve a wireless medium for scheduled access during a first interval; determine a guard time within the first interval, wherein no scheduled transmissions are to occur; and perform one or more unscheduled transmissions via the wireless medium during the guard time.

In another example, another wireless device for arranging an SAI is disclosed. The wireless device may include: means for reserving a wireless medium for scheduled access during a first interval; means for determining a guard time within the first interval, wherein no scheduled transmissions are to occur; and means for performing one or more unscheduled transmissions via the wireless medium during the guard time.

### BRIEF DESCRIPTION OF THE DRAWINGS

The example embodiments are illustrated by way of example and are not intended to be limited by the figures of the accompanying drawings, where:

FIG. 1 shows a block diagram of a wireless system within which the example embodiments may be implemented.

FIG. 2 shows a block diagram of a wireless station (STA) in accordance with example embodiments.

FIG. 3 shows a block diagram of an access point (AP) in accordance with example embodiments.

FIG. 4 shows a time sequence diagram, depicting the coordination of an example scheduled access interval, in accordance with some example embodiments.

FIG. 5 shows a time sequence diagram, depicting the coordination of an example scheduled access interval, in accordance with some example embodiments.

FIG. 6 shows a time sequence diagram, depicting the coordination of an example scheduled access interval, in accordance with some example embodiments.

FIG. 7 shows an illustrative flow chart depicting example operations for coordinating a scheduled access interval, in accordance with some example embodiments.

FIG. 8 shows an illustrative flow chart depicting example operations for coordinating a scheduled access interval, in accordance with some example embodiments.

FIG. 9 shows an illustrative flow chart depicting example operations for coordinating a scheduled access interval, in accordance with some example embodiments.

Like reference numerals refer to corresponding parts throughout the drawing figures.

### DETAILED DESCRIPTION

The example embodiments are described below in the context of WLAN systems for simplicity only. It is to be understood that the example embodiments are equally applicable to other wireless networks (e.g., cellular networks, pico networks, femto networks, satellite networks), as well as for systems using signals of one or more wired standards or protocols (e.g., Ethernet and/or HomePlug/PLC standards). As used herein, the terms “WLAN” and “Wi-Fi®” may include communications governed by the IEEE 802.11 family of standards, BLUETOOTH® (Bluetooth, BT), HiperLAN (a set of wireless standards, comparable to the IEEE 802.11 standards, used primarily in Europe), wireless personal area network (WPAN, e.g., communications governed by IEEE 802.15.4), and other technologies having relatively short radio propagation range. Thus, the terms “WLAN” and “Wi-Fi” may be used interchangeably herein. In addition, although described below in terms of an infrastructure WLAN system including one or more APs and a number of STAs, the example embodiments are equally applicable to other WLAN systems including, for example, multiple WLANs, peer-to-peer (or Independent Basic Service Set) systems, Wi-Fi Direct systems, and/or Hotspots. In addition, although described herein in terms of exchanging data frames between wireless devices, the example embodiments may be applied to the exchange of any data unit, packet, and/or frame between wireless devices. Thus, the term “frame” may include any frame, packet, or data unit such as, for example, protocol data units (PDUs), media access control (MAC) protocol data units (MPDUs), and physical layer convergence procedure protocol data units (PPDUs). The term “A-MPDU” may refer to aggregated MPDUs.

In the following description, numerous specific details are set forth such as examples of specific components, circuits, and processes to provide a thorough understanding of the present disclosure. The term “coupled” as used herein means connected directly to or connected through one or more intervening components or circuits. The term “legacy device” or “legacy STA” may refer to a wireless device which is capable of communication using an older version of a wireless protocol band/or does not support newer versions of the wireless protocol. For example, a legacy Wi-Fi device may be capable of communication using the IEEE 802.11a, 802.11b, and/or 802.11g standards, but may not support the IEEE 802.11n, 802.11ac, 802.11ah, or 802.11ad standards.

Also, in the following description and for purposes of explanation, specific nomenclature is set forth to provide a thorough understanding of the example embodiments. However, it will be apparent to one skilled in the art that these specific details may not be required to practice the example embodiments. In other instances, well-known circuits and devices are shown in block diagram form to avoid obscuring the present disclosure. The example embodiments are not to be construed as limited to specific examples described herein but rather to include within their scopes all embodiments defined by the appended claims.

As described above, wireless devices in a WLAN may support different channel access protocols. For example, some wireless devices may be legacy wireless devices—that do not support newer channel access protocols—while other wireless devices in the WLAN may support one or more new channel access protocols. Some new channel access protocols provide for channel access via scheduling mechanisms (e.g., in contrast to the random access mechanisms used in legacy 802.11 protocols). Problems may arise when legacy devices contend for medium access, and interfere with devices using the new channel access protocols. While it may be desirable to provide fair channel access opportunities for legacy devices, it may also be desirable to allow non-legacy devices to benefit from the improved performance provided by new channel access protocols.

The example embodiments recognize that it would be desirable to provide first time periods during which wireless devices may communicate using newer channel access protocols without (or with reduced risk of) interference by legacy devices. For example, legacy devices may be unlikely to attempt to access the wireless medium during the first time periods. During second time periods (e.g., outside the first time periods), the WLAN may operate in accordance with legacy-compatible channel access protocols, thereby providing opportunities for legacy devices to access the wireless medium.

In accordance with example embodiments, methods and apparatus are disclosed that may allow a wireless device to obtain medium access via a random channel access mechanism, such as a contention-based channel access mechanism. After obtaining medium access, the wireless device may transmit a scheduled access interval announcement (SAIA) message, such as a clear to send (CTS) frame, announcing the beginning and indicating the duration of a scheduled access interval (SAI). During the SAI, the wireless device may control the scheduling of transmissions using a new channel access protocol. According to some embodiments, this SAI may be a dedicated protocol interval (DPI) during which time communications on the channel may be restricted to a particular channel access protocol. SAI-capable Wi-Fi devices that receive the SAIA message (e.g., CTS frame) may set their network allocation vector (NAV) accordingly, and defer from unscheduled medium access for the indicated duration. Legacy Wi-Fi devices that receive the SAIA message may set their NAV accordingly, and defer from all medium access for the indicated duration. Consequently, legacy Wi-Fi devices may be prevented from interfering with scheduled communications during the SAI.

Although a particular wireless device may control the scheduling of transmissions for the duration of a scheduled access interval, scheduled communications may not occur immediately. For example, there may be a period of inactivity from the time the wireless device obtains medium access, and announces an SAI, to the time the first scheduled transmission begins. Such a period of time may be called a “guard time,” and may be an inefficient use of the medium (e.g., since no transmissions are scheduled and other devices defer from medium access). However, the wireless device has medium access during the guard time, and knows when the first scheduled transmission will begin. Accordingly, in the example embodiments, the wireless device may make efficient use of the guard time by carrying out its own Wi-Fi transmissions, during the guard time, and ceasing these transmissions before the first scheduled transmission is to occur. These and other details of the example embodiments, which provide one or more technical solutions to the aforementioned technical problems, are described in more detail below.

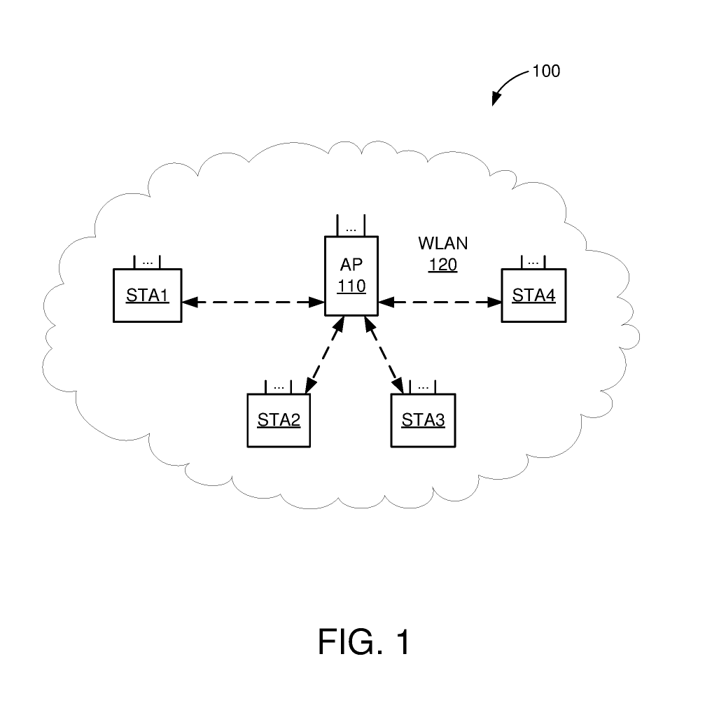

FIG. 1 is a block diagram of a wireless system 100 within which the example embodiments may be implemented. The wireless system 100 is shown to include four wireless stations STA1-STA4, a wireless access point (AP) 110, and a wireless local area network (WLAN) 120. The WLAN 120 may be formed by a plurality of Wi-Fi access points (APs) that may operate according to the IEEE 802.11 family of standards (or according to other suitable wireless protocols). Thus, although only one AP 110 is shown in FIG. 1 for simplicity, it is to be understood that WLAN 120 may be formed by any number of access points such as AP 110. The AP 110 is assigned a unique MAC address that is programmed therein by, for example, the manufacturer of the access point. Similarly, each of STA1-STA4 is also assigned a unique MAC address. For some embodiments, the wireless system 100 may correspond to a multiple-input multiple-output (MIMO) wireless network. Further, although the WLAN 120 is depicted in FIG. 1 as a BSS, for other example embodiments, WLAN 120 may be an infrastructure BSS (IBSS), an ad-hoc network, or a peer-to-peer (P2P) network (e.g., operating according to the Wi-Fi Direct protocols).

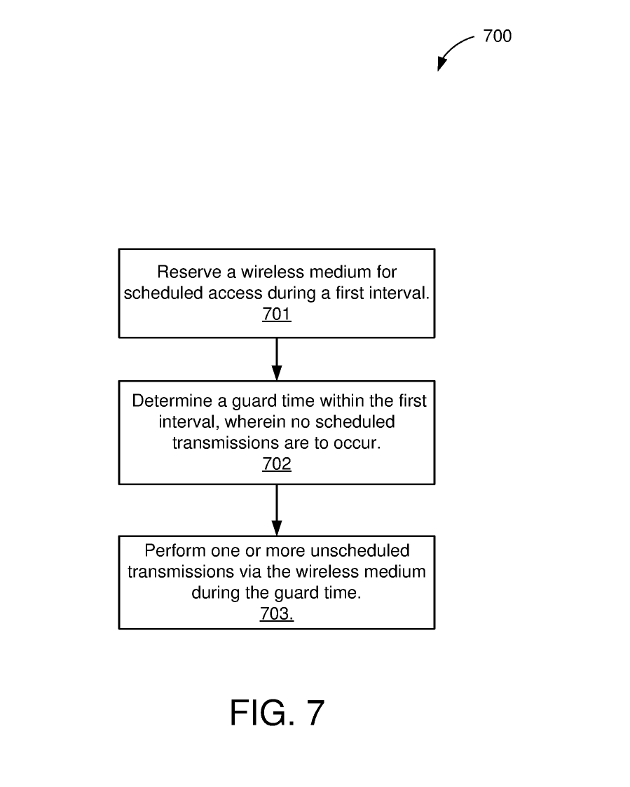

Each of stations STA1-STA4 may be any suitable Wi-Fi enabled wireless device including, for example, a cell phone, personal digital assistant (PDA), tablet device, laptop computer, or the like. Each station STA may also be referred to as a user equipment (UE), a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. For at least some embodiments, each station STA may include one or more transceivers, one or more processing resources (e.g., processors and/or ASICs), one or more memory resources, and a power source (e.g., a battery). The memory resources may include a non-transitory computer-readable medium (e.g., one or more nonvolatile memory elements, such as EPROM, EEPROM, Flash memory, a hard drive, etc.) that stores instructions for performing operations described below with respect to FIG. 7.

The AP 110 may be any suitable device that allows one or more wireless devices to connect to a network (e.g., a local area network (LAN), wide area network (WAN), metropolitan area network (MAN), and/or the Internet) via AP 110 using Wi-Fi, Bluetooth, or any other suitable wireless communication standards. For at least one embodiment, AP 110 may include one or more transceivers, one or more processing resources (e.g., processors and/or ASICs), one or more memory resources, and a power source. The memory resources may include a non-transitory computer-readable medium (e.g., one or more nonvolatile memory elements, such as EPROM, EEPROM, Flash memory, a hard drive, etc.) that stores instructions for performing operations described below with respect to FIG. 7.

For the stations STA1-STA4 and/or AP 110, the one or more transceivers may include Wi-Fi transceivers, Bluetooth transceivers, cellular transceivers, and/or other suitable radio frequency (RF) transceivers (not shown for simplicity) to transmit and receive wireless communication signals. Each transceiver may communicate with other wireless devices in distinct operating frequency bands and/or using distinct communication protocols. For example, the Wi-Fi transceiver may communicate within a 900 MHz frequency band, a 2.4 GHz frequency band, a 5 GHz frequency band, and/or within a 60 GHz frequency band in accordance with the IEEE 802.11 family of standards. The cellular transceiver may communicate within various RF frequency bands in accordance with a 4G Long Term Evolution (LTE) protocol described by the 3rd Generation Partnership Project (3GPP) (e.g., between approximately 700 MHz and approximately 3.9 GHz) and/or in accordance with other cellular protocols (e.g., a Global System for Mobile (GSM) communications protocol). In other embodiments, the transceivers included within the STA may be any technically feasible transceiver such as a ZigBee transceiver described by a specification from the ZigBee Alliance, a WiGig transceiver, and/or a HomePlug transceiver described by a specification from the HomePlug Alliance.

One or more stations STA1-STA4 may be a legacy device, which may not support one or more wireless communication protocols supported by the AP 110 and/or other STAs in the WLAN 120. For example, a legacy device may be capable of communicating according to the IEEE 802.11a, 802.11b, or 802.11g standards, but may not support newer standards such as the IEEE 802.11n, 802.11ac, 802.11ah, and/or 802.11ad standards.

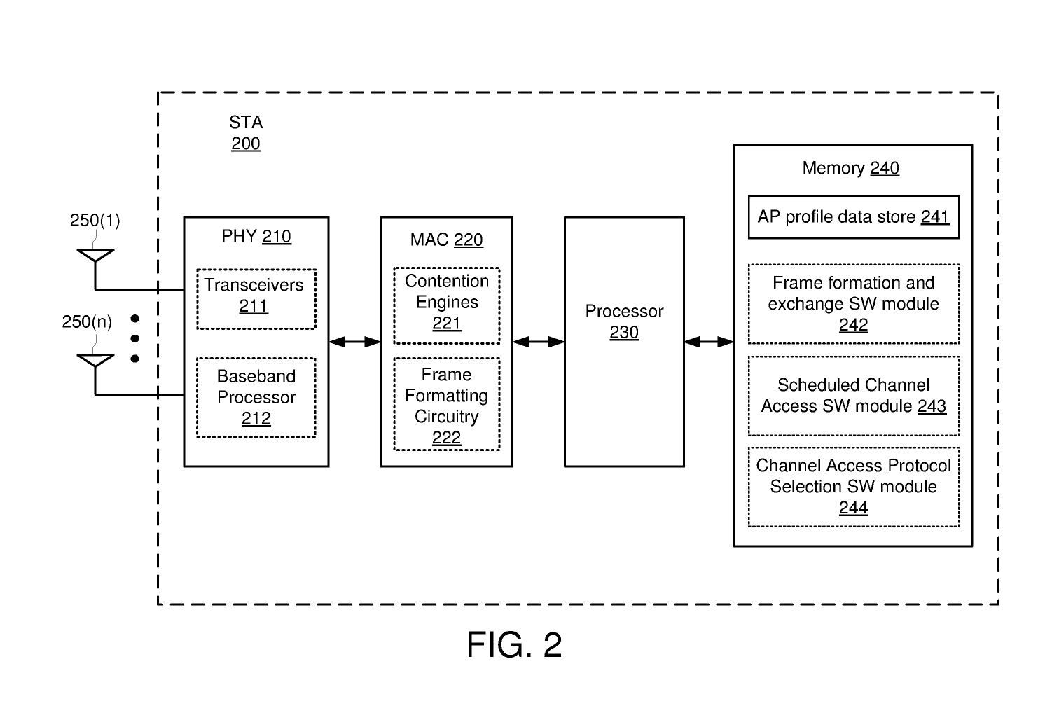

FIG. 2 shows an example STA 200 that may be one embodiment of one or more of the stations STA1-STA4 of FIG. 1. The STA 200 may include a physical layer (PHY) device 210 including at least a number of transceivers 211 and a baseband processor 212, a MAC 220 including at least a number of contention engines 221 and frame formatting circuitry 222, a processor 230, a memory 240, and a number of antennas 250(1)-250(n). The transceivers 211 may be coupled to antennas 250(1)-250(n), either directly or through an antenna selection circuit (not shown for simplicity). The transceivers 211 may be used to transmit signals to and receive signals from AP 110 and/or other STAs (see also FIG. 1), and may be used to scan the surrounding environment to detect and identify nearby access points and/or other STAs (e.g., within wireless range of STA 200). Although not shown in FIG. 2 for simplicity, the transceivers 211 may include any number of transmit chains to process and transmit signals to other wireless devices via antennas 250(1)-250(n), and may include any number of receive chains to process signals received from antennas 250(1)-250(n). Thus, for example embodiments, the STA 200 may be configured for multiple-input, multiple-output (MIMO) operations. The MIMO operations may include single-user MIMO (SU-MIMO) operations and multi-user MIMO (MU-MIMO) operations.

The baseband processor 212 may be used to process signals received from processor 230 and/or memory 240 and to forward the processed signals to transceivers 211 for transmission via one or more of antennas 250(1)-250(n), and may be used to process signals received from one or more of antennas 250(1)-250(n) via transceivers 211 and to forward the processed signals to processor 230 and/or memory 240.

The contention engines 221 may contend for access to one or more shared wireless mediums, and may also store packets for transmission over the one or more shared wireless mediums. The STA 200 may include one or more contention engines 221 for each of a plurality of different access categories. For other embodiments, the contention engines 221 may be separate from MAC 220. For still other embodiments, the contention engines 221 may be implemented as one or more software modules (e.g., stored in memory 240 or stored in memory provided within MAC 220) containing instructions that, when executed by processor 230, perform the functions of contention engines 221.

The frame formatting circuitry 222 may be used to create and/or format frames received from processor 230 and/or memory 240 (e.g., by adding MAC headers to PDUs provided by processor 230), and may be used to re-format frames received from PHY device 210 (e.g., by stripping MAC headers from frames received from PHY device 210).

Memory 240 may include an AP profile data store 241 that stores profile information for a plurality of APs. The profile information for a particular AP may include information including, for example, the AP's SSID, MAC address, channel information, received signal strength indicator (RSSI) values, goodput values, channel state information (CSI), supported data rates, supported channel access protocols, connection history with STA 200, a trustworthiness value of the AP (e.g., indicating a level of confidence about the AP's location, etc.), and any other suitable information pertaining to or describing the operation of the AP.

Memory 240 may also include a non-transitory computer-readable medium (e.g., one or more nonvolatile memory elements, such as EPROM, EEPROM, Flash memory, a hard drive, and so on) that may store at least the following software (SW) modules:
a frame formatting and exchange software module 242 to create and exchange any suitable frames (e.g., data frames, action frames, and management frames) between STA 200 and other wireless devices (e.g., as described for one or more operations of FIG. 7);
a scheduled channel access software module 243 to create, transmit and receive SAIA messages, and to schedule transmissions during an SAI (e.g., as described for one or more operations of FIG. 7); and
a channel access protocol selection software module 244 to select appropriate channel access protocols to be used during legacy-compatible intervals, guard times and during SAls (e.g., as described for one or more operations of FIG. 7).
   Each software module includes instructions that, when executed by processor 230, cause STA 200 to perform the corresponding functions. The non-transitory computer-readable medium of memory 240 thus includes instructions for performing all or a portion of the STA-side operations depicted in FIG. 7.

Processor 230, which is shown in the example of FIG. 2 as coupled to PHY device 210, to MAC 220, and to memory 240, may be any suitable one or more processors capable of executing scripts or instructions of one or more software programs stored in STA 200 (e.g., within memory 240). For example, processor 230 may execute the frame formatting and exchange software module 242 to create and exchange any suitable frames (e.g., data frames, action frames, and management frames) between STA 200 and other wireless devices. Processor 230 may also execute the scheduled channel access software module 243 to create, transmit and receive SAIA messages, and to schedule transmissions during an SAI. Processor 230 may also execute the channel access protocol selection software module 244 to select appropriate channel access protocols to be used during legacy-compatible intervals, guard times and during SAIs.

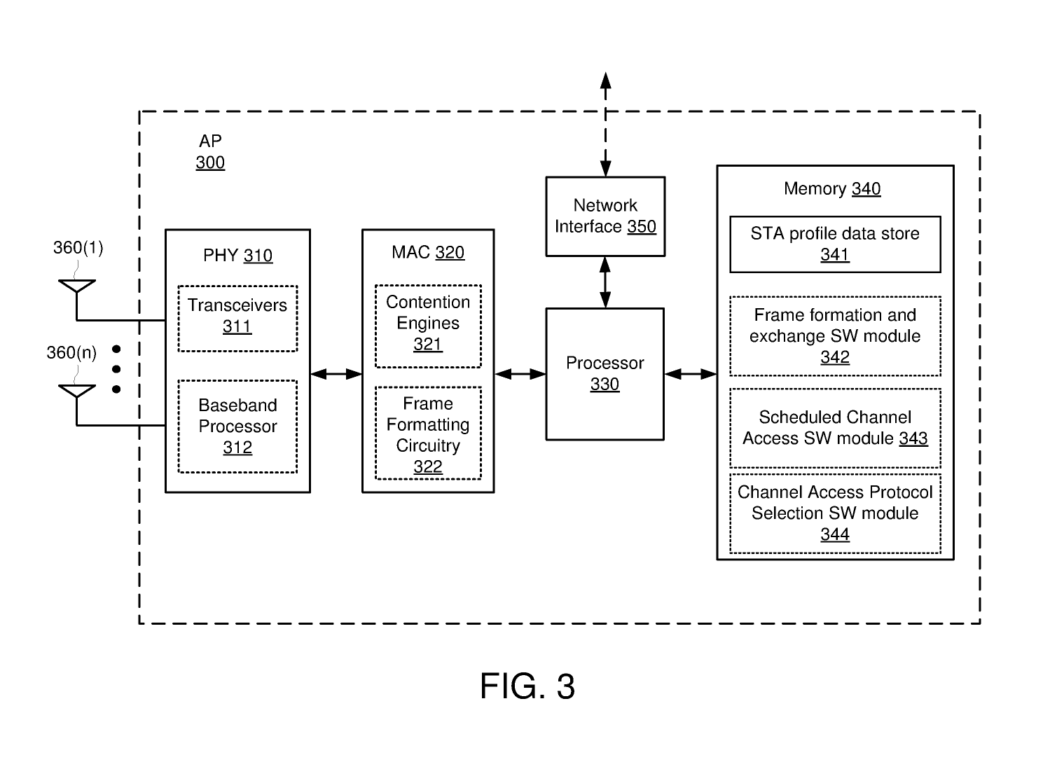

FIG. 3 shows an example AP 300 that may be one embodiment of the AP 110 of FIG. 1. AP 300 may include a PHY device 310 including at least a number of transceivers 311 and a baseband processor 312, may include a MAC 320 including at least a number of contention engines 321 and frame formatting circuitry 322, may include a processor 330, may include a memory 340, may include a network interface 350, and may include a number of antennas 360(1)-360(n). The transceivers 311 may be coupled to antennas 360(1)-360(n), either directly or through an antenna selection circuit (not shown for simplicity). The transceivers 311 may be used to communicate wirelessly with one or more STAs, with one or more other APs, and/or with other suitable devices. Although not shown in FIG. 3 for simplicity, the transceivers 311 may include any number of transmit chains to process and transmit signals to other wireless devices via antennas 360(1)-360(n), and may include any number of receive chains to process signals received from antennas 360(1)-360(n). Thus, for example embodiments, the AP 300 may be configured for MIMO operations including, for example, SU-MIMO operations and MU-MIMO operations.

The baseband processor 312 may be used to process signals received from processor 330 and/or memory 340 and to forward the processed signals to transceivers 311 for transmission via one or more of antennas 360(1)-360(n), and may be used to process signals received from one or more of antennas 360(1)-360(n) via transceivers 311 and to forward the processed signals to processor 330 and/or memory 340.

The network interface 350 may be used to communicate with a WLAN server (not shown for simplicity) either directly or via one or more intervening networks and to transmit signals.

Processor 330 may be any suitable one or more processors capable of executing scripts or instructions of one or more software programs stored in AP 300 (e.g., within memory 340).

The contention engines 321 may contend for access to the shared wireless medium, and may also store packets for transmission over the shared wireless medium. For some embodiments, AP 300 may include one or more contention engines 321 for each of a plurality of different access categories. For other embodiments, the contention engines 321 may be separate from MAC 320. For still other embodiments, the contention engines 321 may be implemented as one or more software modules (e.g., stored in memory 340 or within memory provided within MAC 320) containing instructions that, when executed by processor 330, perform the functions of contention engines 321.

The frame formatting circuitry 322 may be used to create and/or format frames received from processor 330 and/or memory 340 (e.g., by adding MAC headers to PDUs provided by processor 330), and may be used to re-format frames received from PHY device 310 (e.g., by stripping MAC headers from frames received from PHY device 310).

Memory 340 may include a STA profile data store 341 that stores profile information for a plurality of STAs. The profile information for a particular STA may include information including, for example, its MAC address, previous AP-initiated channel sounding requests, supported data rates, supported channel access protocols, connection history with AP 300, and any other suitable information pertaining to or describing the operation of the STA.

Memory 340 may also include a non-transitory computer-readable medium (e.g., one or more nonvolatile memory elements, such as EPROM, EEPROM, Flash memory, a hard drive, and so on) that may store at least the following software (SW) modules:
a frame formatting and exchange software module 342 to create and exchange any suitable frames (e.g., data frames, action frames, and management frames) between AP 300 and other wireless devices (e.g., as described for one or more operations of FIG. 7);
a scheduled channel access software module 343 to create, transmit and receive SAIA messages, and to schedule transmissions during an SAI (e.g., as described for one or more operations of FIG. 7); and
a channel access protocol selection software module 344 to select appropriate channel access protocols to be used during legacy-compatible intervals, guard times, and during SAIs (e.g., as described for one or more operations of FIG. 7).
   Each software module includes instructions that, when executed by processor 330, cause AP 300 to perform the corresponding functions. The non-transitory computer-readable medium of memory 340 thus includes instructions for performing all or a portion of the AP-side operations depicted in FIG. 7.

Processor 330 may execute the frame formatting and exchange software module 342 to create and exchange any suitable frames (e.g., data frames, action frames, and management frames) between AP 300 and other wireless devices. Processor 330 may also execute the scheduled channel access software module 343 to create, transmit and receive SAIA messages, and to schedule transmissions during an SAI. Processor 330 may also execute the channel access protocol selection software module 344 to select appropriate channel access protocols to be used during legacy-compatible intervals, guard times, and during SAIs.

The example embodiments may provide first time periods during which one or more wireless devices may communicate using newer channel access protocols, without interference and/or interruption by legacy devices. The newer channel access protocols may provide for scheduled medium access (e.g., in contrast to contention-based random access). Legacy devices may not support some of the newer channel access protocols, and may contend for medium access in ways that may interfere with scheduled transmissions. Accordingly, legacy devices may be prevented from communicating during the first time periods. The example embodiments may further provide for second time periods (e.g., outside of these first time periods), during which a wireless system may be configured for legacy-compatible medium access. Accordingly, example embodiments may allow a wireless device to announce a scheduled access interval (SAI) during which legacy devices may not attempt to access the wireless medium, for example, and during which the wireless device may control and schedule transmissions.

Although a particular wireless device may control the scheduling of transmissions for the duration of a scheduled access interval, scheduled communications may not occur immediately. For example, there may be a period of inactivity from the time the wireless device obtains medium access to the time the first scheduled transmission begins. Such a period of time may be called a guard time and may be an inefficient use of the medium (e.g., since no transmissions are scheduled and other Wi-Fi devices defer from medium access). However, the wireless device has medium access during the guard time and knows when the first scheduled transmission will begin. Accordingly, in the example embodiments, the wireless device may make efficient use of the guard time by carrying out its own Wi-Fi transmissions during the guard time. Furthermore, because the wireless device knows when the guard time will end, the wireless device may cease such transmissions before the end of the guard time (i.e., before the first scheduled transmission is to occur). In another exemplary embodiment, one or more other unscheduled transmissions may take place during the guard time.

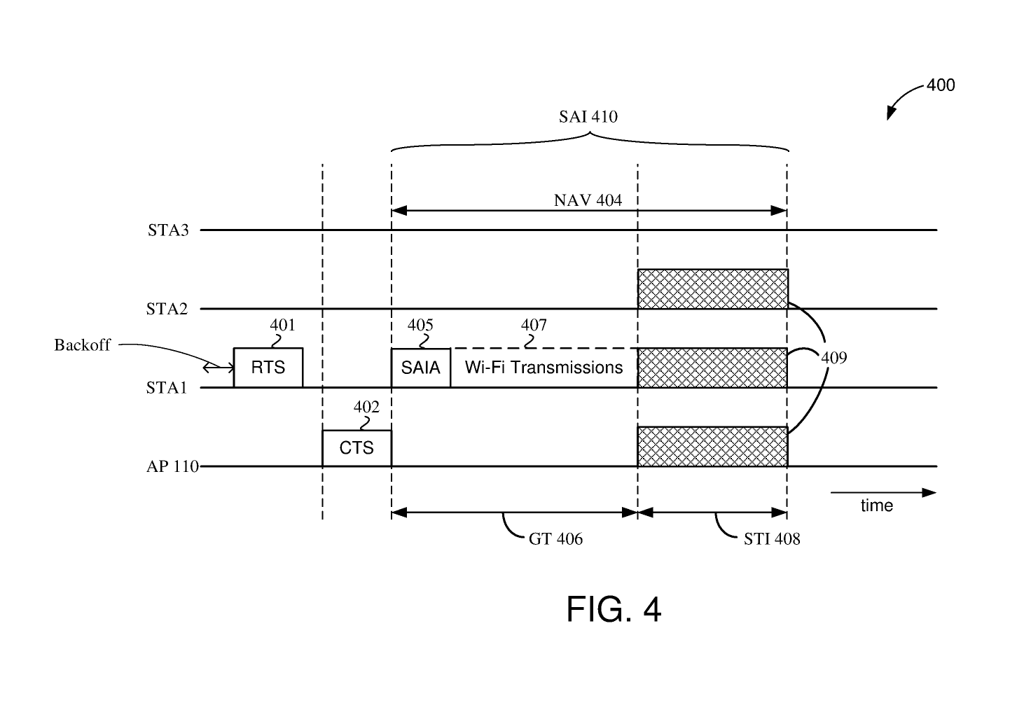

FIG. 4 is a time sequence diagram 400 showing an example scheduled access interval, in accordance with some embodiments. According to some example embodiments, a first device STA1—which may be any suitable STA or AP, such as STA 200 of FIG. 2 or AP 300 of FIG. 3—may contend for medium access. After waiting for a random backoff period, STA1 may transmit a request to send (RTS) frame 401 to reserve the wireless medium for a scheduled access interval (SAI) 410. The RTS frame 401 may indicate a requested duration for the upcoming SAI 410. AP 110 may transmit a CTS frame 402, also indicating the requested duration of the SAI 410, in response to RTS frame 401. Note that while time sequence diagram 400 shows AP 110 transmitting CTS frame 402, in practice the CTS frame 402 may be transmitted by any suitable STA or AP in the wireless network (e.g., such as STA2 or STA3). SAI-capable devices (e.g., AP 110, STA1 and STA2) may receive the CTS frame 402, set their respective NAVs to the duration indicated by CTS frame 402, and defer from accessing the medium using random access mechanisms (e.g., contention-based channel access mechanisms defined by the IEEE 802.11 standards). STA3—which may be a legacy device—may also receive CTS frame 402. In response, STA3 may set its NAV 404 to the duration indicated by CTS frame 402, and defer from medium access for the duration of the SAI 410.

After receiving CTS frame 402, STA1 may transmit an SAIA message 405 indicating the details of the SAI 410, such as a guard time (GT) 406, a transmission schedule, etc. Because SAI-capable devices may defer from unscheduled medium access during an SAI, and legacy devices may defer from any medium access during an SAI, only STA1 may access the medium during guard time 406. In accordance with example embodiments, STA1 may use guard time 406 to perform Wi-Fi transmissions 407. In some aspects, STA1 may complete its Wi-Fi transmissions 407 before guard time 406 ends, and a scheduled transmissions interval (STI) 408 begins. In accordance with some embodiments, SAI-capable devices may be required to stay awake, during guard time 406, to listen for Wi-Fi transmissions 407 from STA1. In accordance with some embodiments, STA1 directs Wi-Fi transmissions 407 only to SAI-capable devices during guard time 406, because legacy devices may not be awake to receive transmissions during the SAI 410. According to some other embodiments, legacy devices may be required to stay awake during guard time 406, for example, to listen for Wi-Fi transmissions 407 from STA1. Before guard time 406 ends, STA1 may complete Wi-Fi transmissions 407 and prepare for scheduled transmissions 409. Note that while each of the scheduled transmissions 409 is shown as one block in time sequence diagram 400, in practice each of the scheduled transmissions 409 may include any number of separate scheduled communications.

In accordance with some other embodiments, an SAIA message may be sent immediately after a random backoff period (e.g., rather than after a RTS/CTS exchange). For example, the SAIA message may correspond to a CTS message transmitted to a predetermined MAC address (which may be called a “dedicated CTS”). In accordance with some embodiments, the predetermined MAC address may be a unique MAC address, such as a specific unicast MAC address, assigned for use in SAI configuration by a standards body such as the IEEE Standards Association (IEEE-SA). In accordance with some other embodiments, the predetermined MAC address may be the MAC address of an existing device which has been rendered inoperable or been retired and thus not using the MAC address. In accordance with further embodiments, the predetermined MAC address may be defined by a company, organization, or standard when the SAI is used exclusively by devices built or operated by that company or organization, or according to that standard. In accordance with some embodiments, the predetermined MAC address may be predetermined by the protocol employed during the SAI. Alternatively, a wireless device may communicate the predetermined MAC address and its meaning using, e.g., a management frame exchange or a beacon frame. Using a dedicated CTS frame as an SAIA message may allow for an SAI to be established using fewer frame exchanges, while still ensuring that legacy devices may receive the dedicated CTS frame, set their respective NAVs to the value indicated in the CTS frame, and defer from medium access for the duration of the SAI.

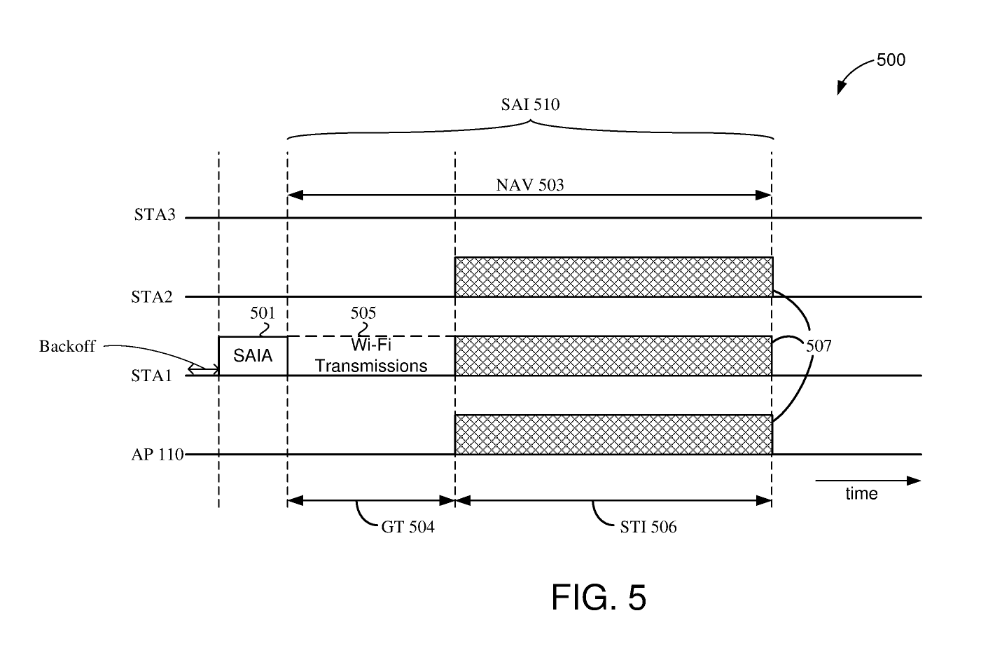

FIG. 5 is a time sequence diagram 500 showing an example scheduled access interval, in accordance with some embodiments. As described above, a first device STA1—which may be any suitable STA or AP, such as STA 200 of FIG. 2 or AP 300 of FIG. 3—may contend for medium access. After waiting a random backoff period, STA1 may transmit an SAIA message 501 to reserve the wireless medium for a scheduled access interval (SAI) 510. The SAIA message 501 may indicate the duration and the parameters of the SAI 510. In accordance with some embodiments, the SAIA message 501 may be a dedicated CTS message sent to a predetermined MAC address. SAI-capable devices (e.g., AP 110, STA1 and STA2) may receive the SAIA message 501, set their NAVs to the duration indicated by the SAIA message 501 (e.g., a duration extending to the end of the SAI 510), and defer from accessing the medium using random access mechanisms (e.g., contention-based channel access mechanisms defined by the IEEE 802.11 standards). STA3—which may be a legacy device—may also receive SAIA message 501. In response, STA3 may set its NAV 503 to the duration indicated by SAIA message 501, and defer from medium access for the duration of the SAI 510.

SAIA message 501 may also indicate a guard time (GT) 504, and a transmission schedule associated with the SAI 510. Because SAI-capable devices may defer from unscheduled medium access during an SAI, and legacy devices may defer from all medium access during an SAI, only STA1 may access the medium during guard time 504. In accordance with example embodiments, STA1 may use guard time 504 to perform Wi-Fi transmissions 505. In some aspects, STA1 may complete its Wi-Fi transmissions 505 before guard time 504 ends, and a scheduled transmissions interval (STI) 506 begins. In accordance with some embodiments, SAI-capable devices may be required to stay awake, during guard time 504, to listen for Wi-Fi transmissions 505 from STA1. In accordance with some embodiments, STA1 directs Wi-Fi transmissions 505 only to SAI-capable devices, because legacy devices may not be awake to receive transmissions during the SAI 510. According to some other embodiments, legacy devices may be required to stay awake during guard time 504, for example, to listen for Wi-Fi transmissions 505 from STA1. Before guard time 504 ends, STA1 may complete Wi-Fi transmissions 505 and prepare for scheduled transmissions 507. Note that while each of the scheduled transmissions 507 is shown as one block in time sequence diagram 500, in practice each of the scheduled transmissions 507 may include any number of separate scheduled communications.

In accordance with some other embodiments, scheduling information may be specified by the protocol used during the SAI 510 rather than being specified within the SAIA message 501 or other messages exchanged among SAI-capable devices. For example, a protocol may specify a predetermined guard time and/or a schedule for scheduled transmissions during the SAI 510.

One potential issue may arise if a device—such as a legacy device or an SAI-capable device—is out of range of the SAIA message 501 or is otherwise unable to receive the SAIA message 501 (e.g., the device is transmitting and not listening for the SAIA message 501). Such devices may be called “hidden nodes,” and may attempt to access the medium during the SAI 510 using random access mechanisms, causing interferences and interruptions to wireless communications with other devices. To mitigate these problems, in accordance with some embodiments, SAI-capable devices may respond to an SAIA message—such as a dedicated CTS frame—by repeating the SAIA message. A legacy hidden node may be more likely to receive a repeated SAIA message, and defer from medium access during the SAI. Similarly, an SAI-capable hidden node may also receive a repeated SAIA message, and defer from unscheduled medium access during the SAI.

In accordance with some example embodiments, SAIA messages comprising dedicated CTS messages may be concurrently transmitted and still be received and decoded correctly by legacy devices. For example, because each dedicated CTS message is sent to the same MAC address, the concurrent dedicated CTS messages may appear to legacy devices as one or more reflections of the other dedicated CTS messages. For other example embodiments, a predefined method may be used for generating each dedicated CTS message, for example, such that the physical layer (PHY) portions of each dedicated CTS message are also identical. For example, a fixed scrambler initialization sequence may be used when generating each dedicated CTS message. Additionally, the Modulation and Coding Scheme (MCS) or PHY rate at which dedicated CTS messages are sent may also be predefined (e.g., by a protocol standard). Because each dedicated CTS message includes the same contents, dedicated CTS messages transmitted in parallel may appear as reflections to receiving legacy devices.

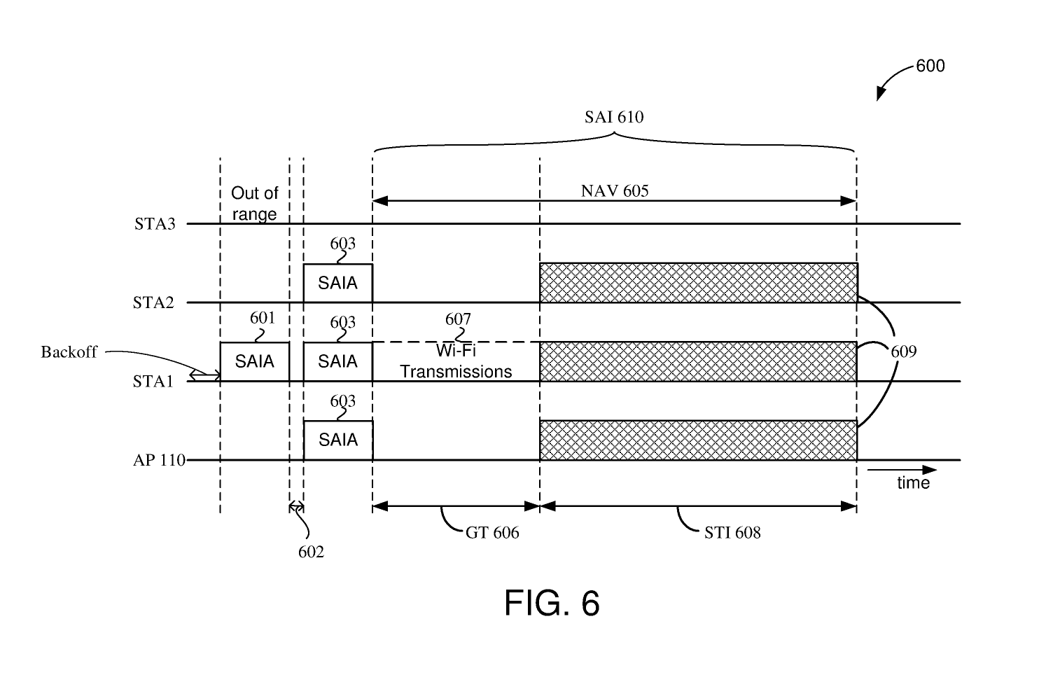

FIG. 6 is a time sequence diagram 600 showing an example scheduled access interval, in accordance with some embodiments. As described above, a first device STA1—which may be any suitable STA or AP, such as STA 200 of FIG. 2 or AP 300 of FIG. 3—may contend for medium access. After waiting a random backoff period, STA1 may transmit an SAIA message 601 to reserve the wireless medium for a scheduled access interval (SAI) 610. The SAIA message 601 may indicate the duration and the parameters of the SAI 610. In accordance with some embodiments, the SAIA message 601 may be a dedicated CTS frame sent to a predetermined MAC address. SAI-capable devices (e.g., AP 110, STA1 and STA2) may receive the SAIA message 601. However, hidden node STA3, which may be a legacy device, may not receive SAIA message 601 (e.g., as STA3 may be out of range). After receiving SAIA message 601, SAI-capable devices may wait a predetermined time interval 602—which may be, e.g., a short inter-frame space (SIFS) or another suitable inter-frame space—before transmitting repeated SAIA messages 603. Although out of range of STA1, hidden node STA3 is more likely to be within range of at least one of AP 110 and/or STA2, and may receive one or more of repeated SAIA messages 603. STA3 may then set its NAV 605 to the duration indicated in the repeated SAIA message 603, and defer from medium access for the duration of the SAI 610.

SAIA message 601—and repeated SAIA messages 603—may also indicate a guard time (GT) 606 and a transmission schedule associated with the SAI 610. Because SAI-capable devices may defer from unscheduled medium access during an SAI, and legacy devices may defer from all medium access during an SAI, only STA1 may access the medium during guard time 606. In accordance with example embodiments, STA1 may use guard time 606 to perform Wi-Fi transmissions 607. In some aspects, STA1 may complete its Wi-Fi transmissions 607 before guard time 606 ends, and a scheduled transmissions interval (STI) 608 begins. In accordance with some embodiments, SAI-capable devices may be required to stay awake, during guard time 606, to listen for Wi-Fi transmissions 607 from STA1. In accordance with some embodiments, STA1 directs Wi-Fi transmissions 607 only to SAI-capable devices, because legacy devices may not be awake to receive transmissions during the SAI. According to some other embodiments, legacy devices may be required to stay awake during guard time 606, for example, to listen for Wi-Fi transmissions 607 from STA1. Before guard time 606 ends, STA1 may complete Wi-Fi transmissions 607 and prepare for scheduled transmissions 609. Note that while each of the scheduled transmissions 609 is shown as one block in time sequence diagram 600, in practice each of the scheduled transmissions 609 may include any number of separate scheduled communications.

In some instances, a hidden node may be unable to receive one or more repeated SAIA messages (e.g., because of transmitting at the same time the repeated SAIA messages are on the transmission medium). In other instances, multiple hidden nodes may be present and out of range of multiple SAI-capable devices. In such situations multiple repetitions of SAIA messages may be required to reach all hidden nodes. Thus, while SAI-capable devices only repeat SAIA message 601 once in the example of FIG. 6, in other embodiments, SAIA messages may be repeated any numbers of times by any number of devices.

According to some embodiments, SAI-capable devices may schedule, in advance, the transmission of one or multiple sequential SAIA messages—such as multiple dedicated CTS messages. For example, a device may transmit an SAIA message indicating a time to schedule one or more dedicated CTS messages. In other embodiments, SAI-capable STAs may have time synchronization information for scheduling the transmission of one or more dedicated CTS messages. According to further embodiments, a wireless protocol used during an SAI may facilitate the scheduling of one or more dedicated CTS messages. At the scheduled time(s), the devices may transmit a plurality of dedicated CTS messages concurrently. Such concurrent dedicated CTS transmission may be referred to as a “scheduled CTS burst.” Subsequent scheduled CTS bursts may reach additional hidden nodes and may consequently reduce the probability of interference during the SAI. According to some other embodiments, a wireless protocol used during an SAI may provide capability for scheduling new times for dedicated CTS bursts. For example, a particular protocol may provide scheduling times for one or more dedicated CTS bursts based on factors such as Wi-Fi traffic between SAls.

In accordance with some embodiments, an SAIA message may be a CTS message sent to a specific receiver address. For example, the specific receiver address may be a protocol identifier address, indicating that a response is requested from one or more recipients. A protocol identifier address may be a MAC address comprising two fields: (i) a protocol identifier field for specifying a specific protocol for use during an SAI; and (ii) a sequence identifier field for specifying where the CTS fits within a sequence of CTS messages. For some implementations, protocol identifier addresses may include 6 octets and may include, for example, a 5 octet protocol identifier field and a 1-octet sequence identifier field. However, the protocol identifier field and the sequence identifier fields may have other lengths. The specific address may be a dedicated block of addresses, which may be reserved by an issuing institution (e.g., the IEEE-SA).

A range of MAC addresses may be reserved when implementing an SAIA message comprising a CTS message transmitted to a protocol identifier address. For example, when a protocol address having protocol identifier Pi is used, a range of protocol identifier addresses may be reserved, the range including protocol identifier addresses having protocol identifier Pi and having each allowable value of the sequence identifier field. Such addresses may be reserved by a standards organization such as the IEEE-SA, or by including the block of MAC addresses from inoperable or retired devices.

FIG. 7 is an illustrative flow chart depicting an example operation 700 for coordinating a scheduled access interval, in accordance with some embodiments. As described above, a wireless device may reserve a wireless medium for scheduled access during a first interval (701). The wireless device may be any one of AP 110 or STA1-STA4 of FIG. 1, STA 200 of FIG. 2, or AP 300 of FIG. 3. In some embodiments, the wireless medium may be reserved using a contention-based access mechanism in accordance with one or more IEEE 802.11 protocols. After obtaining medium access, the wireless device may transmit a scheduled access interval (SAI) announcement frame, announcing an upcoming SAI and indicating at least a duration for the SAI and/or an end time of the SAI. According to some embodiments, the SAI announcement frame may also indicate scheduling information for scheduled transmissions to occur during the SAI. According to some other embodiments, the SAI announcement frame may be a dedicated CTS frame, and may be addressed to a specific unicast media access control (MAC) address. In some implementations, SAI-capable devices receiving the SAI announcement frame may retransmit the SAI announcement frame at least once. The wireless device may form and transmit the SAI announcement frame by executing frame formation and exchange software module 242, scheduled channel access software module 243, and/or channel access protocol selection software module 244 of STA 200 of FIG. 2, or by executing frame formation and exchange software module 342, scheduled channel access software module 343, and/or channel access protocol selection software module 344 of AP 300 of FIG. 3.

After reserving the wireless medium, the wireless device may determine a guard time within the first interval, during which no scheduled transmissions are to occur (702). For some embodiments, the wireless device may determine the guard time by executing scheduled channel access software module 243 of STA 200 of FIG. 2 or by executing scheduled channel access software module 343 of AP 300 of FIG. 3. After determining the guard time, the wireless device may perform one or more unscheduled transmissions via the wireless medium during the guard time (703). In some examples, one or more unscheduled transmissions may include one or more Wi-Fi transmissions. The one or more unscheduled transmissions may be performed by executing frame formation and exchange software module 242, scheduled channel access software module 243, and/or channel access protocol selection software module 244 of STA 200 of FIG. 2, or by executing frame formation and exchange software module 342, scheduled channel access software module 343, and/or channel access protocol selection software module 344 of AP 300 of FIG. 3.

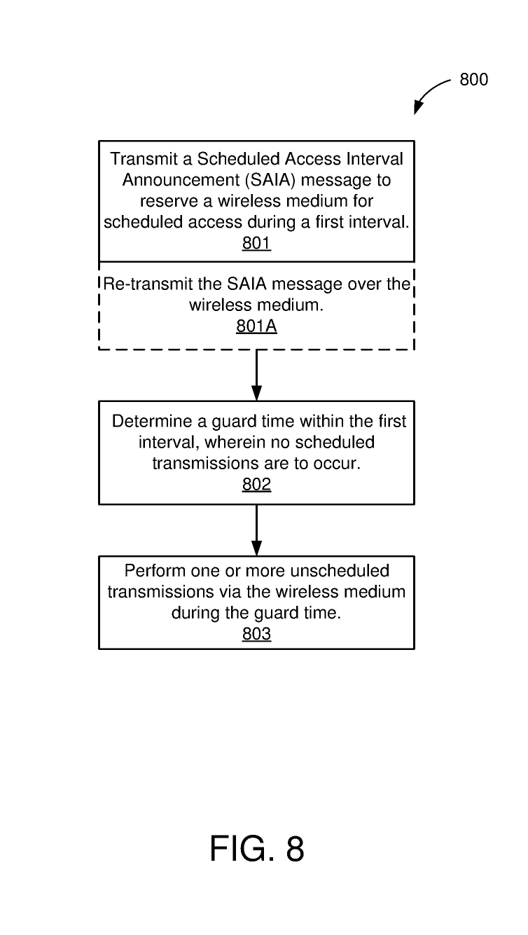

FIG. 8 is an illustrative flow chart depicting an example operation 800 for coordinating a scheduled access interval, in accordance with some embodiments. As described above, a wireless device may transmit a scheduled access interval (SAI) announcement frame to reserve a wireless medium for scheduled access during a first interval (801). The wireless device may be any one of AP 110 or STA1-STA4 of FIG. 1, STA 200 of FIG. 2, or AP 300 of FIG. 3. In some embodiments, the wireless medium may be reserved using a contention-based access mechanism in accordance with one or more IEEE 802.11 protocols. According to some embodiments, the SAI announcement frame may also indicate scheduling information for scheduled transmissions to occur during the SAI. According to some other embodiments, the SAI announcement frame may be a dedicated CTS frame, and may be addressed to a specific unicast media access control (MAC) address. In some implementations, the wireless device may retransmit the SAI announcement frame (801A). The wireless device may form and transmit the SAI announcement frame by executing frame formation and exchange software module 242, scheduled channel access software module 243, and/or channel access protocol selection software module 244 of STA 200 of FIG. 2, or by executing frame formation and exchange software module 342, scheduled channel access software module 343, and/or channel access protocol selection software module 344 of AP 300 of FIG. 3.

After reserving the wireless medium by transmitting the SAIA message, the wireless device may determine a guard time within the first interval, during which no scheduled transmissions are to occur (802). For some embodiments, the wireless device may determine the guard time by executing scheduled channel access software module 243 of STA 200 of FIG. 2 or by executing scheduled channel access software module 343 of AP 300 of FIG. 3. After determining the guard time, the wireless device may perform one or more unscheduled transmissions via the wireless medium during the guard time (803). In some examples, one or more unscheduled transmissions may include one or more Wi-Fi transmissions. The one or more unscheduled transmissions may be performed by executing frame formation and exchange software module 242, scheduled channel access software module 243, and/or channel access protocol selection software module 244 of STA 200 of FIG. 2, or by executing frame formation and exchange software module 342, scheduled channel access software module 343, and/or channel access protocol selection software module 344 of AP 300 of FIG. 3.

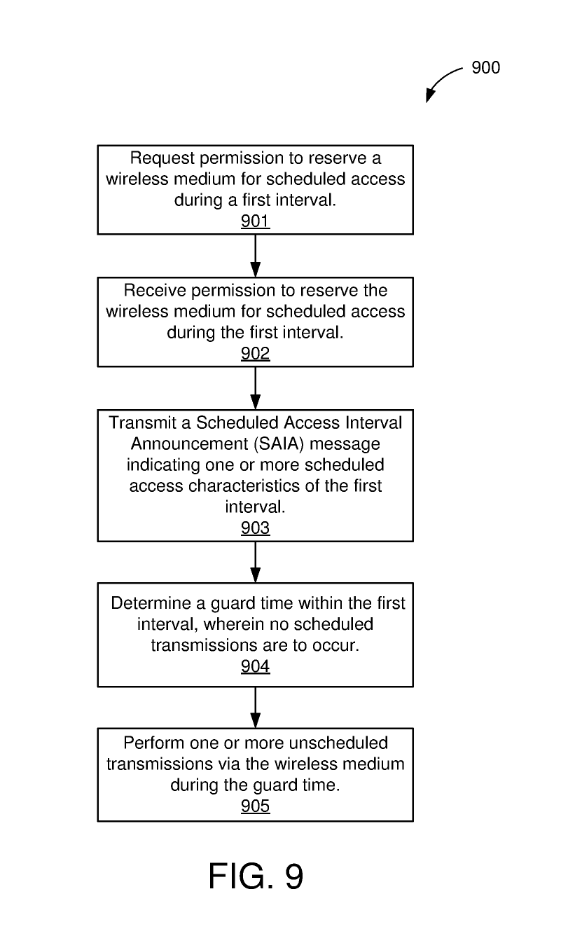

FIG. 9 is an illustrative flow chart depicting an example operation 900 for coordinating a scheduled access interval, in accordance with some embodiments. As described above, a wireless device may request permission to reserve a wireless medium for scheduled access during a first interval (901). The wireless device may be any one of AP 110 or STA1-STA4 of FIG. 1, STA 200 of FIG. 2, or AP 300 of FIG. 3. According to some embodiments, the wireless device may request permission by transmitting a request-to-send (RTS) frame. The wireless device may form and transmit the RTS frame by executing frame formation and exchange software module 242, scheduled channel access software module 243, and/or channel access protocol selection software module 244 of STA 200 of FIG. 2, or by executing frame formation and exchange software module 342, scheduled channel access software module 343, and/or channel access protocol selection software module 344 of AP 300 of FIG. 3. The wireless device may then receive permission to reserve the wireless medium for scheduled access during the first interval (902). In some embodiments, receiving permission may include receiving a clear-to-send (CTS) frame from a second wireless device.

After receiving permission to reserve the wireless medium, the wireless device may transmit a scheduled access interval (SAI) announcement frame indicating one or more scheduled access characteristics of the first interval (903). According to some embodiments, the SAI announcement frame may also indicate scheduling information for scheduled transmissions to occur during the SAI. According to some other embodiments, the SAI announcement frame may be a dedicated CTS frame, and may be addressed to a specific unicast media access control (MAC) address. In some implementations, the wireless device may retransmit the SAI announcement frame. The wireless device may form and transmit the SAI announcement frame by executing frame formation and exchange software module 242, scheduled channel access software module 243, and/or channel access protocol selection software module 244 of STA 200 of FIG. 2, or by executing frame formation and exchange software module 342, scheduled channel access software module 343, and/or channel access protocol selection software module 344 of AP 300 of FIG. 3.

After transmitting the SAIA message, the wireless device may determine a guard time within the first interval, during which no scheduled transmissions are to occur (904). For some embodiments, the wireless device may determine the guard time by executing scheduled channel access software module 243 of STA 200 of FIG. 2 or by executing scheduled channel access software module 343 of AP 300 of FIG. 3. After determining the guard time, the wireless device may perform one or more unscheduled transmissions via the wireless medium during the guard time (905). In some examples, one or more unscheduled transmissions may include one or more Wi-Fi transmissions. The one or more unscheduled transmissions may be performed by executing frame formation and exchange software module 242, scheduled channel access software module 243, and/or channel access protocol selection software module 244 of STA 200 of FIG. 2, or by executing frame formation and exchange software module 342, scheduled channel access software module 343, and/or channel access protocol selection software module 344 of AP 300 of FIG. 3.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

In the foregoing specification, the example embodiments have been described with reference to specific example embodiments thereof. It will, however, be evident that various modifications and changes may be made thereto without departing from the broader scope of the disclosure as set forth herein. The specification and drawings are, accordingly, to be regarded in an illustrative sense rather than a restrictive sense.

What is claimed is:

1. A method for configuring a scheduled access interval (SAI), the method being performed by a wireless device and comprising:
reserving a wireless medium for scheduled access during a first interval;
determining a guard time, within the first interval, wherein no scheduled transmissions are to occur; and
performing one or more unscheduled transmissions via the wireless medium during the guard time.

2. The method of claim 1, wherein the reserving comprises:
gaining access to a wireless medium via a contention operation.

3. The method of claim 1, wherein the reserving comprises:
transmitting a clear to send (CTS) frame over the wireless medium.

4. The method of claim 3, wherein the CTS frame is addressed to a specific unicast media access control (MAC) address.

5. The method of claim 1, wherein the reserving comprises:
transmitting a scheduled access interval announcement (SAIA) message over the wireless medium.

6. The method of claim 5, wherein the SAIA message indicates at least one from the group consisting of: a duration of the first interval, scheduling information for one or more scheduled transmissions during the first interval, and a transmission protocol to be used during the first interval.

7. The method of claim 5, further comprising:
re-transmitting the SAIA message over the wireless medium.

8. The method of claim 5, wherein the SAIA message indicates a number of times that a receiving wireless device should re-transmit the SAIA message.

9. A wireless device, comprising:
one or more processors; and
a memory storing one or more programs comprising instructions that, when executed by the one or more processors, cause the wireless device to:
reserve a wireless medium for scheduled access during a first interval;
determine a guard time, within the first interval, wherein no scheduled transmissions are to occur; and
perform one or more unscheduled transmissions via the wireless medium during the guard time.

10. The wireless device of claim 9, wherein the memory further comprises instructions which, when executed by the one or more processors to reserve the wireless medium, further cause the wireless device to gain access to the wireless medium via a contention operation.

11. The wireless device of claim 9, wherein the memory further comprises instructions which, when executed by the one or more processors to reserve the wireless medium, further cause the wireless device to transmit a clear to send (CTS) frame over the wireless medium.

12. The wireless device of claim 11, wherein the CTS frame is addressed to a specific unicast media access control (MAC) address.

13. The wireless device of claim 9, wherein the memory further comprises instructions which, when executed by the one or more processors to reserve the wireless medium, further cause the wireless device to transmit a scheduled access interval announcement (SAIA) message over the wireless medium.

14. The wireless device of claim 13, wherein the SAIA message indicates at least one from the group consisting of: a duration of the first interval, scheduling information for one or more scheduled transmissions during the first interval, and a transmission protocol to be used during the first interval.

15. The wireless device of claim 13, wherein the memory further comprises instructions which, when executed by the one or more processors, further cause the wireless device to re-transmit the SAIA message over the wireless medium.

16. The wireless device of claim 13, wherein the SAIA message indicates a number of times that a receiving wireless device should re-transmit the SAIA message.

17. A non-transitory computer-readable storage medium storing one or more programs comprising instructions that, when executed by one or more processors of a wireless device, cause the wireless device to:
reserve a wireless medium for scheduled access during a first interval;
determine a guard time, within the first interval, wherein no scheduled transmissions are to occur; and
perform one or more unscheduled transmissions via the wireless medium during the guard time.

18. The non-transitory computer-readable storage medium of claim 17, wherein the instructions which when executed to cause the wireless device to reserve the wireless medium further cause the wireless device to gain access to the wireless medium via a contention operation.

19. The non-transitory computer-readable storage medium of claim 17, wherein the instructions which when executed to cause the wireless device to reserve the wireless medium further cause the wireless device to transmit a clear to send (CTS) frame over the wireless medium.

20. The non-transitory computer-readable storage medium of claim 19, wherein the CTS frame is addressed to a specific unicast media access control (MAC) address.

21. The non-transitory computer-readable storage medium of claim 17, wherein the instructions which when executed to cause the device to reserve the wireless medium further cause the wireless device to transmit a scheduled access interval announcement (SAIA) message over the wireless medium.

22. The non-transitory computer-readable storage medium of claim 21, wherein the SAIA message indicates at least one from the group consisting of: a duration of the first interval, scheduling information for one or more scheduled transmissions during the first interval, and a transmission protocol to be used during the first interval.

23. The non-transitory computer-readable storage medium of claim 21, wherein the instructions when executed further cause the wireless device to re-transmit the SAIA message over the wireless medium.

24. The non-transitory computer-readable storage medium of claim 21, wherein the SAIA message indicates a number of times that a receiving wireless device should re-transmit the SAIA message.

25. A wireless device for arranging a scheduled access interval (SAI), the wireless device comprising:
means for reserving a wireless medium for scheduled access during a first interval;
means for determining a guard time, within the first interval, wherein no scheduled transmissions are to occur; and
means for performing one or more unscheduled transmissions via the wireless medium during the guard time.

26. The wireless device of claim 25, wherein the means for reserving comprises means for gaining access to a wireless medium via a contention operation.

27. The wireless device of claim 25, wherein the means for reserving comprises means for transmitting a clear to send (CTS) frame over the wireless medium.

28. The wireless device of claim 27, wherein the CTS frame is addressed to a specific unicast media access control (MAC) address.

29. The wireless device of claim 25, wherein the means for reserving comprises means for transmitting a scheduled access interval announcement (SAIA) message over the wireless medium.

30. The wireless device of claim 29, wherein the SAIA message indicates at least one from the group consisting of: a duration of the first interval, scheduling information for one or more scheduled transmissions during the first interval, and a transmission protocol to be used during the first interval.
